(19) United States
(12) Patent Application Publication
(10) Pub. No.: US 2005/0218554 A1
(43) Pub. Date: Oct. 6, 2005

(54) Solution casting method

(75) Inventor: Naoaki Suzuki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD

(21) Appl. No.: 11/090,297

(22) Filed: Mar. 28, 2005

(30) Foreign Application Priority Data
Mar. 26, 2004 (JP) 2004-091883

(51) Int. Cl. B29C 39/14

(52) U.S. Cl. 264/216; 264/234

(57) ABSTRACT

On a film transporting path in a film production equipment, there are a tension controlling device for controlling a tension to be applied to a TAC film. The tension cont v rolling device has a suction drum to which the TAC film is adsorbed and transported, and a dancer including a dancer roller. The film adsorption force of the suction drum is set in the range of 0.005N/cm² to 0.1N/cm². If the surface temperature of the TAC film is at least 50° C., the loading applied to the dancer roller is determined such that the difference of the tension may be zero or at most 500N/m. Thus it is prevented that hole shape transfers, wrinkles, scratched wounds and the like occur.

### BACKGROUND OF THE INVENTION

1. Field of the Invention

The present invention relates to a solution casting method of producing a cellulose ester film for an optical use.

2. Description Related to the Prior Art

As an example of a film for an optical use, there is a protective film for polarizing filter in a liquid crystal display (LCD). In the films, there is a cellulose ester film produced from triacetyl cellulose and the like, which has an extremely high transparency, a small optical anisotropy and a low retardation. The cellulose ester film is produced by a solution casting method, in which a film thickness becomes usually constant.

In a film production equipment in which a polymer film is produced by the solution casting method, for example, a polymer (such as a triacetylcellulose and the like) is dissolved to a solvent to obtain a dope while several sorts of additives are adequately added to the solvent, and then the dope is cast onto an endless support, such as a metal drum or a belt. When the cast dope has the self-supporting properties, the dope is peeled as a film from the support. The film is transported into a tenter device in which both edge portion of the film are clipped with noncontact to a product portion of the film. After the tenter device, the film is transported into an edge slitting device in which the both edge are slit off or trimmed off, and then into a drying apparatus for drying the film transported by many rollers and with an application of a warm air to the film. The drying apparatus is partitioned into many drying zones, each of which a temperature is determined. After the drying apparatus, the film is obtained as a product film, which is continuously transported to a film winding apparatus disposed in the most downstream side of a transporting line. Therefore, in accordance with use, facility of equipment and the like, several hundreds or thousands meters of the product film is wound onto an cylindrical winding core produced from polymer, metal, wood, paper and the like.

In this film production equipment, since the transporting distance from the drying with transport in the tenter dryer to the winding by the winding apparatus is extremely long, a tension to the transported film becomes lower. Therefore the frictional force between the path roller and the film becomes lower in the drying apparatus in which many rollers are disposed on the film transporting path, and thus the film slips on the rollers to damage a film surface or to cause a transport trouble of the film. Accordingly, as described in Japanese Patent Laid-Open Publication No. 2001-113546, a tension controlling device for controlling the tension to the film is provided in one or more area between the peel roller and the drying apparatus, between the drying zones in the drying apparatus, and between the drying apparatus and the winding apparatus.

As the tension controlling device, for example, a suction drum for transporting the film with absorption thereto is used. Note that the suction drum is usually called a drive drum constructed of a rotary drum, on whose periphery many through holes are formed, and a suctioning apparatus which sucks an outside air through the through holes. Thus the film is transported with adsorption to the periphery of the rotary drum.

By the way, since the film is transported with adsorption to the through holes formed on the periphery of the suction drum, shapes of through holes are sometimes transferred to the film surface at a high film adsorption force, and thus transfer of hole-shapes occurs. Further, when the difference of the tension between the up- and downstream sides from the suction drum changes suddenly (for example, when the difference of the tension increases), the transfer of the hole-shapes and wrinkles occur.

### SUMMARY OF THE INVENTION

An object of the present invention is to provide a solution casting method in which quality failures, such as a scratched wound, a hole print and a wrinkle, don't occur.

In order to achieve the object and the other object, in a solution casting method of the present invention, a dope containing a polymer and a solvent is cast onto a support, and a cast dope is peeled as a film from the support. The film is dried and wound. The film is transported with use of a dancer roller and a suction drum in the drying and/or the winding. The dancer roller is disposed in up- or downstream side from the suction drum. The suction drum performs the transporting with adsorbing to the film at a film adsorption force in the range of 0.005N/cm² to 0.1N/cm². When a temperature of the film is at least 50° C., a difference of tension between the up- and downstream sides from the suction drum is regulated to at most 100N/m, and when a temperature of the film is less than 50° C., the difference of tension is regulated to at most 500N/m. A difference of tension between the up- and downstream sides from the suction drum to at most 500N/m. The film is wound as a film.

Preferably, when a temperature of the film is at least 50° C., the difference of tension is regulated to at most 100N/m.

Further, a difference of a surface temperature between the suction drum and the film at contacting to the suction drum is at most 20° C. Otherwise, a number of the suction drum is at least 2, and at least one of the suction drums contacts to a peeled surface of the film from the support. Furthermore, plural rollers rotating with supporting the film are used for the drying and the winding, and the shift of a center to both edges in a bending of the roller is at most 1 mm.

Particularly preferably, an anti rotation torque per one roller is at most 0.0025 Nm, and a number of the rollers between the neighboring suction drums is at most 200. Especially, a dimple processing is made to a surface of at least one of the rollers, and the film is lapped such that a film lapping angle may be at most 180°.

Preferably, the film is transported while a total electrostatic potential of the transported film is kept to at most 10 kV. Particularly, when the surface temperature of the film is at least 70° C., a neutralization apparatus of a self-discharging type is used for keeping the total electrostatic potential to at most 10 kV, and when the surface temperature of the film is less than 70° C., a neutralization apparatus of superimposed voltage type is used.

According to the solution casting method of the present invention, the suction drum rotates with the adhesion of the periphery thereof to the film, and the dancer roller is used for keeping the constant tension to be applied to the film which is adhered to the suction drum. Since the tension is controlled with use of the suction drum and the dancer roller, the constant tension can be kept. Consequently the hole prints, the wrinkles and the scratched wound that are caused by the fluctuation of the tension to the film can be reduced. Further, the film adsorption force of the suction drum is in the range of 0.005N/cm² to 0.1N/cm². Furthermore if the surface temperature of the TAC film is at least 50° C., the difference of the tension is zero or at most 100N/m, and if the surface temperature of the TAC film is less than 50° C., the difference of the tension is zero or at most 500N/m. Thus it is prevented that hole prints, wrinkles, scratched wounds and the like occur.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a film production equipment to which a solution casting method of the present invention is applied;

FIG. 2 is a schematic diagram of tension controlling device provided on a transporting path of a film in the film production equipment.

### PREFERRED EMBODIMENTS OF THE INVENTION

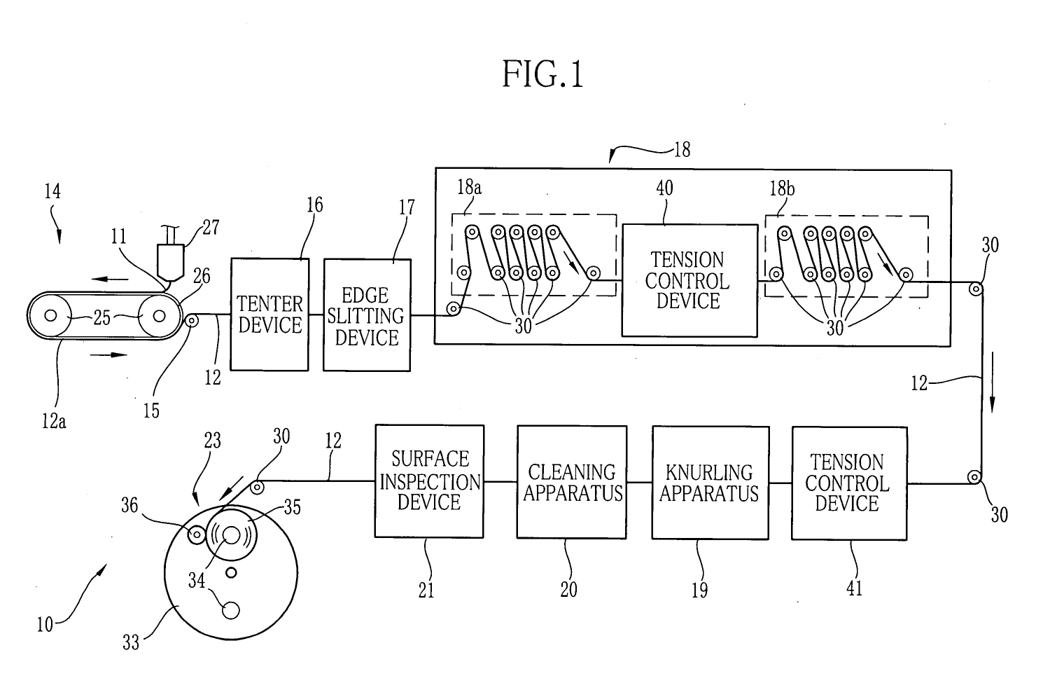

In FIG. 1, a film production equipment 10 can produce several sorts of films from a dope prepared from already known solvents and additives, and in this embodiment, the film production equipment 10 produces a cellulose triacetate film (hereinafter TAC film) 12 from a dope 11 prepared by adequately adding several sorts of solvents and additives to a cellulose triacetate which is one of cellulose ester and often used as a raw material for a film for optical use, such as a protective film for a polarizing filter in the LCD.

In the film production equipment 10, a transport path is provided with a casting apparatus 14, a peel roller 15, a tenter device 16, an edge slitting device 17, a drying device 18, a knurling device 19, a cleaning device 20, an automatic surface inspection device 21, a winding apparatus 23 and the like sequentially. Note that an alignment of these devices and apparatuses is not restricted and the alignment thereof may be changed.

The casting apparatus 14 is constructed of a metallic belt 26 which is supported by a pair of drums 25 and circularly moves in a counterclockwise direction of the figure, and a casting die for casting onto the belt 26 a dope which is fed from a preparing tank for preparing and stirring the dope 11. The dope 11 in the preparing tank is cast at a predetermined casting rate onto the belt 26 with use of a casting die 27. The cast dope 11 forms a casting film 12a on the belt 26, and the solvent is gradually evaporated by drying with an hot air, such that the casting film 12a may form a TAC film 12 having a self-supporting properties. Then the TAC film 12 is peeled by the peel roller 15 provided near the belt 26. The TAC film 12 is transported by guide rollers (not shown) and in effect of the peel roller 15 and a tension to the TAC film 12 at the peeling.

In the tenter device 16, both edge portions of the TAC film 12 are clipped by tenter clips disposed on track thereof (not shown), so as to apply the tension to the TAC film 12. Thus the tenter clips stretches the TAC film 12 with a feed of a dry air from a dry air feeding device. Therefore the TAC film 12 is transported with the noncontact to the product portion thereof and dried.

Further, after the TAC film 12 is discharged from the tenter device 16, both edge portions of the TAC film 12 that are deformed by the clipping of the tenter clips are slit off or trimmed off by the edge slitting device 17 which is disposed downstream from the tenter device 16. Thereafter, the TAC film 12 is transported along rollers 30 on the transporting path, since being harder than just after the peeling at which the TAC film 12 is not enough hard.

The TAC film 12 after the slit of the edge portions by the edge slitting device 17 is transported to the drying apparatus 18, which is partitioned to plural drying zones in accordance with the drying temperature for drying the TAC film 12. It is to be noted in this embodiment that the drying apparatus 18 is partitioned into two drying zones, namely a first drying zone 18a and a second drying zone 18b, in each of which the TAC film 12 is guided by plural rollers 30 disposed in upper and lower side of this figure and an air feeder (not shown) feeds a drying air to dry the TAC film 12 transported. In each of the drying zone, the TAC film 12 is partially lapped on the upper and lower rollers alternately so as to increase the transporting distance. Then the drying air whose wind speed and temperature is controlled during the transporting of the TAC film 12. Since the drying air is fed out from the air feeder, the TAC film 12 becomes harder. Note in this embodiment that the number of the drying zone is two. However, the number is not restricted in this embodiment and may be three or more. Furthermore, a cooling zone for cooling the TAC film 12 may be disposed in a downstream side from each of the drying zone.

The length of the rollers 30 disposed on the transporting path or in the drying apparatus 18 is larger than a width of the TAC film 12, and from 1700 mm to 1800 mm in this embodiment. Further, as described below in detail, each roller bends or deformed in effect of weight of the roller and a tension applied to the TAC film 12. If the bending (namely a bending deflection of a center to both edges in the deformation) of each roller becomes larger, the TAC film 12 as a film product has the wrinkles. Therefore, the rollers 30 are formed of metallic materials such as iron, aluminum and the like or a carbon fiber-reinforced plastic (CFRP) such that the creep may be less than 1 mm, and the diameter of the roller to be used is at least φ60 mm.

Further, if a lap angle of the TAC film 12 lapped onto each roller 30 is at most 80°, the frictional force between the roller 30 and the TAC film 12 becomes lower while the periphery of the roller is smooth. Thus the TAC film 12 sometimes slips to form scratched wounds. Note that the lap angle means a center angle between front and back edges of contact portion of the TAC film 12 to the roller 30. Therefore, a dimple processing is preferably made to a surface of at least one of the rollers 30 whose lap angle is less than 180°. Further, even if the anti-rotation torque is too high, the transported TAC film 12 sometimes slips on the periphery of the roller such that the scratched wound may be formed. Therefore, the anti-rotation torque per one roller 30 is preferably at most 0.025 Nm.

The TAC film 12 after hardening in the drying apparatus 18 is transported to the knurling device 19 to perform the knurling to both edge portions. The knurling means to substantially make the thickness of both edge portion of the film larger in the processing which is usually called a knurling-embossing. Thus when the TAC film 12 is wound up or coiled as the TAC film 12 by the winding apparatus 23, the displacement of the wound TAC film 12 is prevented. Note that when the temperature of TAC film 12 is high, the edge portions of the TAC film 12 are stretched in effect of the knurling pressure. Therefore the TAC film 12 after the drying is preferably cooled in the cooling zone or on a transporting path, such that a surface temperature may be at most 100° C. Further, the knurling is made to both side edges and the trimming (slitting-off) of both edge portions which are not usable is made. Thereafter the TAC film 12 is transported into a cleaning device 20.

In the cleaning device 20, foreign materials adhered on the film surface of the TAC film 12 are removed. The preferable cleaning device 20 does not form the scratched wound on the film surface and has capability of removing the foreign materials on the film surface of the TAC film 12. For example, the preferable cleaning device 20 is an air nozzle for feeding air to the film surface so as to remove the foreign materials, a rubber roller (cleaning roller) which the foreign materials are adhered to by contacting the film surface, and the like. Note that if the temperature of the film surface of the TAC film 12 is high, the foreign materials are hardly removed, and therefore it is preferable to decrease the surface temperature to at most 100° C. before the TAC film 12 is transported into the cleaning device 20. Thereafter, the TAC film 12 after the removal of the foreign materials in the cleaning device 20 is transported to a surface inspection device 21, so as to make the inspection whether the foreign materials remain or scratched wounds are formed on the film surface.

The inspection device 21 inspects for example with use of a CCD camera which takes an image of the TAC film 12 for inspecting on the basis of the image data whether the foreign materials remain and scratched wounds are formed. Preferably, the inspection device 21 has such an inspection capability as to inspect the foreign materials and the scratched wounds of at least 10 μm as the quality failure. Further, the inspection device 21 preferably has a calculation function so as to calculate the inspection result of the quality failure. Thus the inspection device lets an operator know the number of generation of the quality failure, and if the number of the foreign materials and the scratched wounds in an area of 1 m becomes more than a predetermined number, the marking is made in the area so as to make the discrimination of the defective area easily. Thereafter, the TAC film 12 after the completion of the inspection is transported to the winding apparatus 23 and wound as the TAC film 12 into a film roll.

As the winding apparatus 23, there are several sorts of the winding apparatus, such as turret type and a single shaft type. However, any sort of the winding apparatus may be used in the present invention. In this embodiment is used the winding apparatus of the double shaft turret type which can continuously wind the film. The winding apparatus 23 includes a turret 33, a roll core 34 which is set to the turret 33, and an automatic rewinding machine (not shown) for rewinding the TAC film 12 around the new roll core 34. The winding apparatus 23 rewinds the continuously transported TAC film 12 to a film roll 35 at a winding speed which is from 20% to 100% to the transporting speed. In the winding apparatus 23, if the tension (winding tension) to be applied to the TAC film is large, the winding pressure (or winding-nip pressure) becomes so large to form the winkles on the film surface. Therefore, the tension fluctuation of winding the TAC film 12 is preferably at most 50(N), and particularly at most 30(N).

Further, the winding apparatus 23 is provided with a rayon roller 36 for pressing a film surface of the film roll 35. Thus it is prevented that an air is spooled up into the film roll 35. The length of the rayon roller 36 is the same as or at most 250 mm smaller than the width of the TAC film 12. Further, if the winding tension is described as T(N/m), the pressure F(N) of the rayon roller 36 for pressing the film roll 35 is preferably controlled so as to satisfy a condition of 3 F<T<10 F. Furthermore, instead of pressing the film roll 35 with use of the pressing roller such as the rayon roller 36, an air nozzle may be used for pressing the film roll by applying the air pressure.

In and between the devices and apparatuses of the film production equipment 10, there are neutralization devices (not shown) for maing the neutralization of the static charge which the TAC film 12 slides on the rollers 30 and the rubber roller to generate. Note, there are parts of the film production equipment 10, in which the temperature of the film surface is at least 70° C. These parts is preferably provided with the neutralization apparatus of the self-discharging type for making the neutralization by discharging the static charge to an earthed conductive fiber (or neutralizing brush). When the film surface is less than 70° C., the neutralization apparatus of superimposed voltage type is used for the neutralization. Further, the neutralization devices preferably regulate a total electrostatic potential of the transported TAC film 12 in the film production equipment 10 to at most 10 kV.

Further, the production method of the TAC film with use of the above devices and apparatuses 14-23 is preferably the film producing method described in Japanese Patent Application No. 2003-319673 & 2003-319811.

In the film production equipment 10, since a transporting distance of the film from drying and transporting in the tenter device 16 to winding by the winding apparatus is extremely long, the tension of the TAC film 12 easily becomes lower during the transportation. Especially, the rollers 30 are disposed in upper and lower side in the drying apparatus 18 and thus lapped by the TAC film 12 alternately in upper and lower side. Therefore the transporting distance becomes so long that the tension becomes lower in the drying apparatus 18 or in up- and downstream side from the drying apparatus 18. In this embodiment, therefore, tension controlling devices 40,41 for controlling the tension to be applied to the TAC film 12 are respectively provided between the first drying zone 18a and the second drying zone 18b and between the drying apparatus 18 and the winding apparatus 23.

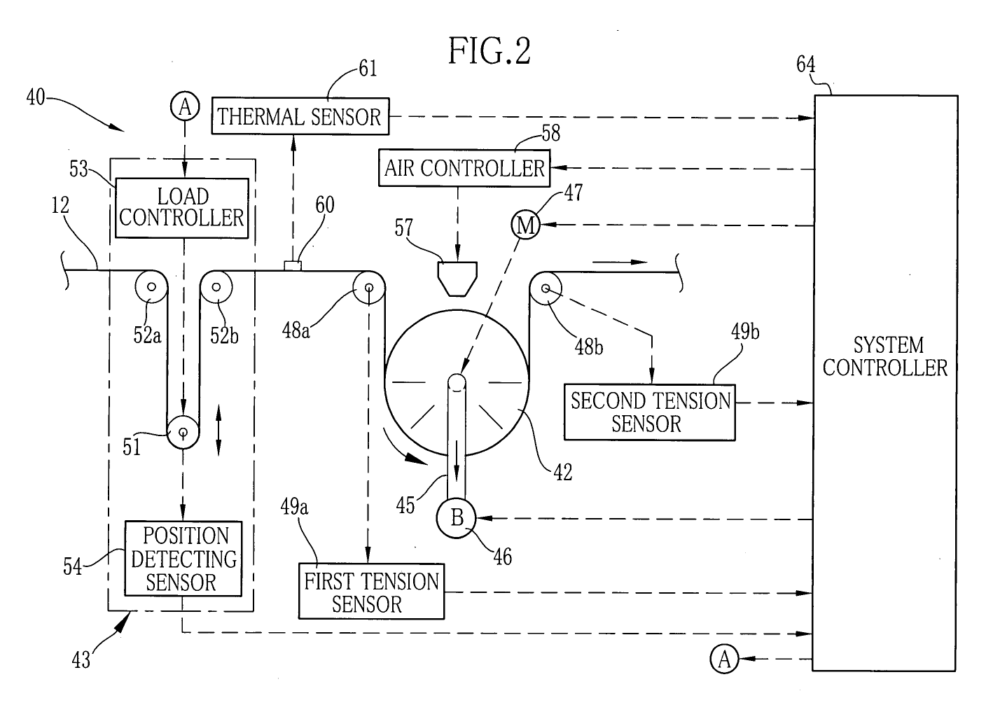

In followings, an explanation of the tension controlling device 40 is made in reference with FIG. 2. Note that since the tension controlling devices 40,41 have the same structure, the explanation of the tension controlling device 41 is omitted.

As shown in FIG. 2, the tension controlling device 40 includes a suction drum 42 for transporting the TAC film 12 with adsorbing thereto, and a dancer device 43 provided in upstream side of the transporting direction from the suction drum 42. In the dancer device 43, the tension of the TAC film before and after the suction drum 42 is determined. Note that the number of the rollers 30 provided between the suction drum 42 and a suction drum (not shown) of the tension controlling device 41 is preferably at most 200. Further, at least one of the suction drums of the tension controlling devices 40,41 is preferably disposed in a side of the surface peeled from the belt 26.

As well known, the suction drum 42 is a hollow cylindrical drum having plural through holes on periphery thereof. An inner space of the suction drum is connected through a pipe 45 to a suction blower 46. Therefore the pressure in the inner space is decreased such that the TAC film is adsorbed to the periphery of the suction drum 42, and a drive motor 47 is driven to rotate the suction drum 42 in counterclockwise direction of this figure with the adsorption. Thus the TAC film 12 is transported into the downstream side. Note that if the film adsorption force of the TAC film 12 onto the suction drum 42 is too low, the TAC film 12 slips on the suction drum 42 to form the scratched wounds. Otherwise, if the film adsorption force is too high, the hole shape transfer occurs. Therefore, in this embodiment, the suction power of the suction blower 46 is regulated such that the film adsorption force of the film may be in the range of 0.005N/cm² to 0.1N/cm².

In the up- and downstream sides from the suction drum 42, there are first and second tension measuring rollers 48a,48b for respectively measuring the tension in up- and downstream sides from the suction drum 42, and first and second tension sensors 49a,49b which are respectively connected to the first and second tension measuring rollers 48a,48b. The difference of the tension between the up- and downstream sides can be calculated on the basis of the measured data of the first and second tension sensors 49a,49b.

In the dancer device 43, there are a dancer roller 51, guide rollers 52a,52b, a load controller 53 for controlling a loading applied to the dancer roller 51, and a position detecting sensor 54 for detecting a position of the dancer roller 51. The dancer roller 51 is movable in up- and downward directions of this figure between the guide rollers 52a,52b. Further, the difference of the tension between the up- and downstream sides from the suction drum 42 is determined depending on the loading to be applied to the dancer roller 51. In this embodiment, the dancer device 43 is provided in the upstream side from the suction drum 42. However, the dancer device 43 may be provided in the downstream side.

In this embodiment, the position of the dancer roller 51 is detected by the position detecting sensor 54. Further, on the basis of the result of the detection, the rotation of the suction drum 42 is controlled such that the dancer roller 51 may be positioned at a middle area between an uppermost position and a lowermost position. For example, when the dancer roller 51 moves from the middle area to the lowermost position, a rotation speed of the suction drum 42 is made higher to move the dancer roller 51 to the middle area. If the film adsorption force of the TAC film 12 to the suction drum 42 is at most 0.005N/cm², the TAC film 12 slips on the suction drum 42, and if the film adsorption force is at least 0.1N/cm², the hole shape transfer occurs. Therefore, in this embodiment, the film adsorption force of the TAC film 12 to the suction drum 42 is set in the range of 0.005N/cm² to 0.1N/cm². Thus the difference of the tension between the up- and downstream sides from the suction drum 42 is kept constant, and the TAC film 12 can be transported without forming the hole shape transfers and the scratched wounds.

Further, if the temperature of the TAC film 12 is higher, the TAC film 12 becomes more flexible, and the scratched wounds are easily formed on the film surface. Therefore, in this embodiment, when the surface temperature of the TAC film 12 is at least 50° C. (for example in the tension controlling device 40), the loading applied to the dancer roller 51 is set such that the difference of the tension between the up- and downstream sides of the suction drum 42 may be zero or at most 100N/m. Further, when the surface temperature of the TAC film 12 is less than 50° C. (for example in the tension controlling device 41), the loading applied to the dancer roller 51 is set such that the difference of the tension may be zero or at most 500N/m.

Furthermore, in transporting the TAC film 12 by the suction drum 42 to which the TAC film 12 is adsorbed, if a temperature difference between the periphery temperature of the suction drum 42 and the surface temperature of the TAC film 12 is large, the TAC film 12 sometimes shrinks and expands. Therefore, an air blow 57 is provided close to a drum periphery of the suction drum 42 for feeding to the drum periphery a warm air whose temperature is controlled. The air blow 57 heats the periphery uniformly over the suction drum 42. The temperature of the air discharged from the air blow 57 can be changed depending on the surface temperature of the TAC film 12 by an air temperature regulating device 58.

The surface temperature of the TAC film 12 is measured with use of a probe 60 and a thermal sensor 61 which is connected to the probe 60. In this embodiment, the probe 60 is disposed between the suction drum 42 and the dancer device 43, and measures the surface temperature of the TAC film 12. As the probe 60, the probes of any features and materials may be optionally selected so far as they doesn't scratch or damage the surface of the transported TAC film 12. Further, in this embodiment, the probe 60 is disposed between the suction drum 42 and the dancer device 43. However, the present invention is not restricted in this embodiment, and the dancer device 43 may be disposed in the upstream side.

On the basis of the results of measuring the surface temperature of the TAC film 12 with use of the probe 60 and the thermal sensor 61, the air temperature regulating device 58 regulates the temperature of the air blow 57 such that the difference between the surface temperature of the TAC film 12 and the periphery temperature of the suction drum 42 is at most 20° C.

Every part of the tension controlling devices 40,41 is controlled by a system controller 64 for controlling the movement and work of the film production equipment 10. To the system controller 64 are connected the suction blower 46, the drive motor 47, the first tension sensor 49a, the second tension sensor 49b, the load controller 53 of the dancer device 43, the position detecting sensor 54 for detecting the position of the dancer roller 51, the thermal sensor 61 an operation panel (not shown) and the like. The system controller 64 controls the load controller 53 to apply the loading to the dancer roller 51, on the basis of the predetermined value of the tension that is input through the operation panel, and controls the drive motor 47 for regulating the rotational speed of the suction drum 42 to keep the dancer roller 51 at the middle area, on the basis of the result of detecting the position by the position detecting sensor 54. Further, the system controller 64 controls the suction blower 46 to regulate the film adsorption force of the TAC film 12 to the suction drum 42, on the basis of the predetermined value of the film adsorption force that is previously input. Furthermore, the system controller 64 controls the air temperature regulating device 58 to regulate the temperature of the warm air fed from the air blow 57, on the basis of the results of detecting the temperature of the film surface with the thermal sensor 61.

Then functions of this embodiment will be described. In the film production equipment 10, when the continuous transport of the TAC film 12 starts, the system controller 64 controls the load controller 53 to apply the loading to the dancer roller 51, on the basis of the predetermined value of the tension that is previously input through the operation panel and the like. When the surface temperature of the TAC film 12 is at least 50° C., the loading applied to the dancer roller 51 is set such that the difference of the tension between the up- and downstream sides of the suction drum 42 may be zero or at most 100N/m. Further, when the surface temperature of the TAC film 12 is less than 50° C., the loading applied to the dancer roller 51 is set such that the difference of the tension may be zero or at most 500N/m. Thus it is prevented that the suction drum 42 scratches or damages the TAC film 12. Thus the TAC film 12 has no scratched wounds.

Furthermore, on the basis of the results of detecting the position of the dancer roller 51 by the position detecting sensor 54, the system controller 64 controls the rotational speed of the suction drum 42 such that the dancer roller 51 may be kept in the middle area between the upper- and lowermost positions, while the film adsorption force of the film to the suction drum is in the range of 0.005N/cm² to 0.1N/cm². Thus the difference of the tension force is controlled in a predetermined range. Further, the scratches caused by the low film adsorption force and the hole-shape transfer caused by the high film adsorption force are prevented.

Further, on the basis of the results of measuring the surface temperature of the TAC film 12 with use of the probe 60 and the thermal sensor 61, the system controller 64 controls the air temperature regulating device 58 to regulate the temperature of the air blow 57. Thus the difference between the surface temperature of the TAC film 12 and the periphery temperature of the suction drum 42 is at most 20° C. Thus the shrink and expansion of the TAC film 12 is prevented, which is caused by the difference between the periphery temperature of the suction drum 42 and the surface temperature of the TAC film 12.

The tension controlling device 40 is provided with a suction drum 42 and the dancer roller 51, and the film adsorption force of the TAC film 12 is in the range of 0.005N/cm² to 0.1N/cm². In this case, if the surface temperature is less than 50° C., the difference of the tension is regulated to zero or at most 500N/m. Thus the transporting defects, such as the hole shape transfers, the wrinkles, the scratched wounds and the like, are prevented.

In this embodiment, the number of the tension controlling devices on the transporting path is two. However, the number is not restricted in the embodiment, and may be one or at least three, depending on the length of the transporting path. In this embodiment, the position of the tension controlling device is not restricted in this embodiment, namely the positions between the first drying zone 18a and the second drying zone 18b and between the drying apparatus 18 and the winding apparatus 23. The tension controlling device may be provided in the upstream side from the drying apparatus 18. Furthermore, if the drying apparatus 18 is partitioned to at least three drying zones, the tension controlling device may be provided between the drying zones.

Further, plural through holes are formed on the periphery of the suction drum 42 in this embodiment. However, in the present invention, the shape and the size of the through holes are not restricted especially, and the through holes may be formed arbitrarily.

In this embodiment, the temperature of the periphery of the suction drum 42 is regulated with use of the air blow 57. However, the present invention is not restricted in it. for example, a heat roller may be disposed so as to contact to the periphery of the suction drum 42 or a heater is provided in the suction drum 42, so as to control the temperature of the periphery.

The present invention is not restricted in the film production equipment for producing the cellulose triacetate film for the optical use, but may be applied to a film production equipment for producing several sorts of the film such as a photosensitive film for taking pictures, polyethylene telephthalate film (PET film) and the like.

### EXAMPLE

In followings, an example of the present invention will be described. Note that the present invention is not restricted in the example. The contents of the dope 11 used for producing the TAC film 12 is as follows.

| | |
|---|---|
| Cellulose triacetate particles | 100 pts. by mass |
| (substitution degree, 2.82; viscometric | |
| average degree of polymerization, | |
| 306; water content, 0.2 mass %; | |
| viscosity of 6 mass % in methylenchloride | |
| solution, 315 mPa · s; averaged | |
| particle diameter, 1.5 mm; standard | |
| deviation of paricles, 0.5 mm). | |
| Dichloromethane (first solvent compound) | 320 pts. by mass |
| Methanol (second solvent compound) | 83 pts. by mass |
| 1-Butanol (third solvent compound) | 3 pts. by mass |
| Plasticizer A (triphenylphosphate) | 7.6 pts. by mass |
| Plasticizer B (diphenylphosphate) | 3.8 pts. by mass |
| UV-absorbing agent a | 0.7 pts. by mass |
| 2-(2′-hydroxy-3′,5′-di-tert-butylphenyl)benzotriazol | |
| UV-absorbing agent b | 0.3 pts. by mass |
| (2-(2′-hydroxy-3′,5′-di-tert-amilphenyl)-5- | |
| chrolobenzotriazol) | |
| Citric acid ester mixture | 0.006 pts. by mass |
| (mixture of citric acid, citric acid monoethyl ester, | |
| citric acid diethyl ester, and citric acid | |
| triethyl ester) | |
| Particles | 0.05 pts. by mass |
| (silica particles having diameter of 15 nm, | |
| and Mohrs hardness about 7) | |

The dope 11 of the above contents was further fed from the preparing tank to the casting die 27 which was 1.8 m in width. The flow rate of the dope 11 cast from a slit of the casting die 27 was controlled such that the thickness of the film 31 after the drying might be 80 μm. Further, the width of the dope cast from the slit of the casting die 27 was 1700 mm.

The belt 26 onto which the casting die 27 casted the dope 11 was endless and made of stainless. Further, the belt 26 was 2.1 m in width, 70 m in length, 1.5 mm in thickness and polished such that the surface roughness might be at most 0.05 μm. The materials of the belt 26 was SUS316 such that the belt 26 might have the enough resistance to corrosion and strength.

The temperature in the casting apparatus 14 was kept at 35° C. with use of a temperature adjusting equipment. The cast dope forms a casting film on the support, and a drying air was fed in a parallel to the casting film so as to dry it. An overall heat transfer coefficient from the drying air to the casting film was 24 kcal/m²·hr·° C. The temperature of the drying air was 135° C. in the upstream side and 140° C. in the downstream side in an upper convey path of the belt 26. Further, an air blower fed an air such that the temperature of a lower path of the belt 26 might be 65° C.

For 5 seconds after the casting, the drying air is not directly fed to the dope 11 and the casting film 12a, and then the fluctuation of the static sound pressure is reduced in the range of −1 Pa to +1 Pa. When the percentage of the solvent in the casting film 12a is 50 mass %, the casting film 12a is peeled as the TAC film 12 with support of the peel roller 15, and transported toward the tenter device 16. In the transport, a drying wind at 40° C. is fed to the TAC film 12 from an air blower (not shown).

The TAC film 12 was transported into the tenter device 16 which is partitioned into three drying zones. The TAC film 12 in the drying zones are transported while the tenter clips clip both side edge portions of the TAC film 12. In this period, the TAC film 12 was dried by feeding the drying airs. The tenter clips were cooled by supplying a heat transfer medium of 20° C. Further, the temperatures of the drying airs into the drying zones are 90° C., 100° C. and 110° C. respectively from the upstream side. After the TAC film 12 exited from the tenter device 16, both edge portions of the TAC film 12 that were 20 mm in the widthwise direction of the TAC film 12 were slit off by the edge slitting device 17.

After the slitting of the edge portions, the TAC film 12 was transported to the drying apparatus 18 including the rollers, and dried at the high temperature therein. The temperature of the drying air into the first drying zone was 120° C., and that into the second drying zone was 130° C.

The tension controlling devices 40,41 were respectively provided in the up- and downstream sides from the second drying zone 18b. The film adsorption force of the suction drum 42 in each tension controlling devices 40,41 was set in the range of 0.005N/cm² to 0.1N/cm². If the surface temperature of the TAC film 12 was at least 50° C., the difference of the tension between the up- and downstream sides of the suction drum 42 was zero or at most 100N/m. If the surface temperature of the TAC film 12 is less than 50° C., the difference of the tension was zero or at most 500N/m.

The TAC film 12 after the drying at the high temperature was cooled during the transporting such that a surface temperature was at most 100° C. The knurling was made by the knurling device 19. The width of the knurling was 10 mm, and the pressure of a knurling roller was determined such that the averaged height of each projection formed by the knurling might be 12 μm larger than an averaged film thickness.

After the knurling, the foreign materials on the film surface were removed from the TAC film 12 by the cleaning device 20. After the inspection of the number of the foreign materials and the scratched wounds on the surface was made by the inspection device 21 provided in downstream side from the cleaning device 20, the TAC film 12 was transported to the winding apparatus 23, which wound the continuously transported TAC film 12 as the TAC film 12 to the film roll 35. The winding speed was from 20% to 100% to the transporting speed. Further, the tension fluctuation of winding the TAC film 12 was regulated to 30(N). Simultaneously, if the winding tension was described as T(N/m), the pressure F(N) of the rayon roller 36 for pressing the film roll 35 was controlled so as to satisfy a condition of 3 F<T<10 F. The neutralization devices, which were disposed between apparatuses and devices, regulated a total electrostatic potential of the transported TAC film 12 in the film production equipment 10 to at most 10 kV.

In order to make the effects of the present invention clear, the TAC film 12 obtained in above Example was compared in quality with a TAC film produced by changing the difference of the tension in the tension controlling devices 40,41.

[Comparison]

As Comparison, if the surface temperature of TAC film 12 was at least 50° C., the difference of the tension between the up- and downstream sides of the suction drum 42 in each tension controlling device 40,41 was 200N/m, and if the surface temperature of the TAC film 12 is less than 50° C., the difference of the tension was 600N/m. Further the TAC film 12 was obtained while the difference between the surface temperature of the suction drum 42 and the temperature of the film surface was at least 30° C. Note that, when the TAC film 12 is produced in both of Example and Comparison, the film adsorption force of the suction drum 42 in each tension controlling devices 40,41 was set in the range of 0.005N/cm² to 0.1N/cm².

The estimations of the TAC film was made in Example and Comparison. When the number of the wounds and the hole shape transfers was the same as or less than the predetermined value which is allowed for the film product, the estimation was “Pass”. When the number of the wounds and the hole shape transfers was more than the predetermined value, the estimation was “Rejection”.

The result of comparing the example with the comparison is shown in Table 1.

TABLE 1

| Temperature of | Tension | Temperature | |
|---|---|---|---|
| film surface | difference (N/m) | Difference (° C.) | Estimation |
| At least 50° C. | At most 100 | At most 20 | Pass |
| | 200 | At least 30 | Rejection |
| Less than 50° C. | At most 500 | At most 20 | Pass |
| | 600 | At least 30 | Rejection |

As shown in Table 1, the number of the formed hole shape transfers and the scratched wounds is the same as or less than the predetermined value when the following conditions are satisfied. First, the difference of the tension is at most 100N/m when the surface temperature of the TAC film 12 is at least 50° C.; the difference of the tension is at most 500N/m when the surface temperature of the TAC film 12 is less than 50° C.; and the difference between the surface temperature of the TAC film 12 and the periphery temperature of the suction drum 42 is at most 20° C.

Various changes and modifications are possible in the present invention and may be understood to be within the present invention.

1. A solution casting method of producing a film from a dope containing a polymer and a solvent, comprising steps of:
casting said dope onto a support;
peeling said cast dope as said film from said support;
drying said film;
winding said film;
transporting said film with use of a dancer roller and a suction drum during the drying and/or the winding, said dancer roller being disposed in up- or downstream side from said suction drum, said suction drum feeding with adsorbing said film at an film adsorption force in the range of 0.005N/cm² to 0.1N/cm^{2;}
wherein when a temperature of said film is at least 50° C., a difference of tension between said up- and downstream sides from said suction drum is regulated to at most 100N/m, and when a temperature of said film is less than 50° C., said difference of tension is regulated to at most 500N/m.

2. A solution casting method defined in claim 1, wherein a difference of a surface temperature between said suction drum and said film at contacting to said suction drum is at most 20° C.

3. A solution casting method defined in claim 1, wherein a number of said suction drum is at least 2, and at least one of said suction drums contacts to a peeled surface of said film from said support.

4. A solution casting method defined in claim 1, wherein plural rollers rotating by supporting said film are used in the drying or the winding, and a bending deflection of a center to both edges in said roller is at most 1 mm.

5. A solution casting method defined in claim 4, wherein an anti-rotation torque per one roller is at most 0.025 Nm, and a number of said rollers in each interval between said two suction drums is at most 200.

6. A solution casting method defined in claim 5, wherein a dimple processing is made to a surface of at least one of said rollers, and said film is lapped on said at least one roller such that a film lapping angle may be at most 180°.

7. A solution casting method defined in claim 1, wherein said film is transported while a total electrostatic potential of the transported film is kept to at most 10 kV.

8. A solution casting method defined in claim 7, wherein when said surface temperature of said film is at least 70° C., a neutralization apparatus of a self-discharging type is used for keeping said total electrostatic potential to at most 10 kV, and when said surface temperature is less than 70° C., a neutralization apparatus of superimposed voltage type is used.
